(19) United States
(12) Patent Application Publication
(10) Pub. No.: US 2008/0288994 A1
(43) Pub. Date: Nov. 20, 2008

(54) Method for Storing Broadcast Contents, and a Broadcast Content Storage System

(75) Inventors: Eric Thelen, Aachen (DE); Dietrich Klakow, Saarbrucken (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/599,881

(22) PCT Filed: Apr. 6, 2005
(86) PCT No.: PCT/IB05/51125

§ 371 Date: Oct. 12, 2006

(30) Foreign Application Priority Data
Apr. 15, 2004 (EP) 04101534.8

(51) Int. Cl. H04N 7/173

(52) U.S. Cl. 725/116

(57) ABSTRACT

The invention describes a method for storing broadcast contents and a broadcast content storage system. A plurality of content categories (KAT1, KAT2) is pre-defined, each of which is defined or described by at least one content descriptor (OB 1, OB2). Broadcast contents transmitted over at least one broadcast transmission channel are received, preferably continually, or over pre-defined lengths of time. Received broadcast contents, which are described by a content descriptor (OB1, OB2), are automatically assigned to the content category (KAT1, KAT2) defined or described by the corresponding content descriptor (OB1, OB2). The broadcast contents assigned to a content category (KAT1, KAT2) and the assignments of the broadcast contents to the corresponding content categories (KAT1, KAT2) are automatically stored.

The invention relates to a method for storing broadcast contents and to a broadcast content storage system.

Rapid technological developments in the area of digital storage techniques in the last decades have led to development of storage media with continually increasing storage capacities. Only recently, for example, VHS (Video-Home-System) technology, used for storing video information, has begun to be replaced by DVD (Digital Versatile Disc) or hard-disk technology. This will soon lead to worldwide application of video recorders with heretofore unknown storage capacities, allowing the recording of a multitude of films without having to change the storage medium.

At the same time, the commercial success of many private broadcasting companies, also called providers, has led to a continually growing supply of programs being broadcast. These programs are commonly referred to collectively as “broadcast contents”, may have any type of format, genre, duration and classification. In this sense, the term “broadcast content” preferably describes radio and/or television programs such as movies, plays, news broadcasts, music chart shows, sports broadcasts, documentaries, etc., and can mean an entire unit, for example an entire movie or an entire news broadcast, or an excerpt of an entire unit, such as only the regional news segment of a news broadcast, or only the top three of the music charts. The huge supply of broadcast contents supplied by the continually growing number of providers makes it increasingly difficult, even with the aid of specialized TV program magazines, for a user to identify the programs he actually would like to watch from the vast supply of available programs.

Even when the user, with the aid of such a TV guide, has managed to find a movie he would like to record, he is still faced with the well-known problem of programming his video recorder in such a way as to actually record this particular movie.

Therefore, an object of the present invention is to provide a method for storing broadcast contents, and a broadcast content storage system allowing user-friendly storage of broadcast contents and a user-friendly access to the stored broadcast contents.

The object of the invention is achieved by the features of the independent claims. Suitable and advantageous developments of the invention are defined by the features of the dependent claims. Further developments of the system claim according to the dependent claims of the method claim are also encompassed by the scope of the invention.

According to the present invention, a plurality of content categories is pre-defined, each of which is defined or described by at least one content descriptor. Broadcast contents transmitted over at least one broadcast transmission channel are received, preferably continually, or over pre-defined lengths of time. Received broadcast contents, which are described by a pre-defined content descriptor, are automatically assigned to the content category defined or described by the corresponding content descriptor. The broadcast contents assigned to a content category and the assignments of the broadcast contents to the corresponding content categories are automatically stored.

To this end, each content category is preferably allocated a logical or physical storage (memory) address indicating a storage sector on a storage medium, for example a hard-disk. The broadcast contents corresponding to a content category are automatically stored to the storage sector defined by the address allocated to the corresponding content category. The storage address can also be defined by a marker or pointer. Therefore, the content must not necessarily be stored in physical slots, e.g. in predefined sectors on a hard-disk or on different hard-disks, but may also be stored in “virtual slots” identified by markers or pointers in a queue.

In a preferred embodiment of the invention, information regarding broadcast contents for a particular content category selected by the user—for example title, duration, or production date of the broadcast content—are automatically displayed for the user. Additionally or alternatively, broadcast contents corresponding to a content category selected by the user are replayed.

By automatically categorising and storing the received broadcast contents in the manner described—in particular according to a definition of the content categories tailored to the user—a selection of broadcast contents can be stored which corresponds to the user's taste. It is no longer necessary to invest time and effort in programming a video recorder. Furthermore, the invention allows the user quick and uncomplicated access to stored broadcast contents for a particular content category.

For example, the invention can be implemented in an intelligent video recorder in the following way: the content categories “Franz Beckenbauer” and “Tagesschau” are defined. The content category “Franz Beckenbauer” is further defined by the content descriptors “voice of Franz Beckenbauer” or “key-word: Franz Beckenbauer”. The content category “Tagesschau” is further defined by the content descriptor “key-word: Tagesschau”. The incoming television channels are continually monitored for the voice of Franz Beckenbauer, the key-word “Franz Beckenbauer” or the key-word “Tagesschau”. For example, if the key-word “Tagesschau” is identified on a received television channel, the program in which the key-word was identified is stored in the content category “Tagesschau”.

The beginning and end of a broadcast content are preferably identified by a suitable method of analysis, or are transmitted as a signal accompaniment to the broadcast content.

Some or all of the content categories and content descriptors can be defined by the user himself, or they might be defined by the broadcast content provider, the manufacturer of the broadcast content storage system, or by a service provider. The content categories and content descriptors might be loaded into the broadcast content storage system, for example, by downloading from the internet.

The term “content descriptor” covers all information suitable for describing a broadcast content, e.g.:
names of actors, newscasters, presenters, talk-show guests;
voices of actors, newscasters, presenters, talk-show guests;
languages of actors, newscasters, presenters, talk-show guests;
topics of documentaries, political discussions, sports shows;
the topicality or year of production of a broadcast content;
audio or video quality of a broadcast content;
key-words or images present in a broadcast content;
title of a documentary, movie, political discussion, or sports show;
genre of a movie or music show (e.g. jazz, 50s movie etc.).

The content descriptors are automatically extracted from the broadcast content, preferably using suitable methods of analysis, and/or can be transmitted along with the broadcast content as accompanying signals. The automatic extraction can take place at point of transmission, upon receiving, or in a central facility of a service provider.

In order to be able to record an entire broadcast content which has been identified during transmission as belonging to a content category, each received broadcast content is preferably stored in a temporary buffer. After content descriptor analysis has been performed on the broadcast content, some or all of the buffered broadcast content can then be allocated to the appropriate content categories and stored to memory, or deleted, as appropriate.

If a received broadcast content can be allocated to more than one content category, it will preferably be stored to one content category's allocated memory, whilst a number of references (pointers) are generated for the remaining content categories, referring to the appropriate memory sector. Naturally, the scope of the invention also allows the broadcast content to be stored a number of times. An appropriate warning can be issued, for example “This broadcast content has already been viewed under content category XYZ!”, so that the user does not end up watching the same broadcast content more than once.

If the storage capacity of the system or the reserved storage capacity for a content category is exhausted, the oldest broadcast content stored in the system or in the appropriate content category might preferably be deleted in order to free up more memory for more current incoming broadcast contents.

Alternatively or additionally, broadcast contents that the user has already replayed might be deleted to free up memory space, or broadcast contents belonging to a content category that the user has flagged as unimportant might be deleted. Replay of a broadcast content might involve replaying the entire broadcast content, or might involve displaying only certain information, such as the title or a summary of the content. Furthermore, if storage capacity is exhausted, incoming broadcast contents might simply not be recorded, or the user might be informed visually or audibly about the storage capacity status. Certain broadcast contents might preferably be flagged by user input as particularly interesting, so that these are not deleted from memory after viewing, but are particularly protected from deletion.

If the association of a broadcast content to a content category is not described in a binary manner (“relevant for content category XY”, “not relevant for content category XY”), but rather by degrees of association (“very relevant for content category XY” “fairly relevant for content category XY” “not relevant for content category XY”), a broadcast content, in an alternative or additional method to the methods described above for freeing up memory space, might be deleted on the basis of relevance, so that less relevant stored broadcast contents are deleted, or a previously stored broadcast content with lower relevance than an incoming one is deleted to make room for the incoming broadcast content.

In a preferred embodiment of the invention, a broadcast content may be described by a content descriptor when the degree of association between content descriptor and broadcast content has been found to exceed a pre-defined threshold level, using suitable methods of analysis such as speaker identification or speech recognition.

The status of the stored broadcast contents can be displayed quantitatively, preferably broken down according to content category and/or the specified degree of association.

Additionally or alternatively to the quantitative display, the display might also indicate which of the stored broadcast contents have already been viewed by the user, and which have not yet been viewed. This information can also be broken down according to content category and can be shown visually, for example by appropriate LEDs, an LCD (liquid crystal display) on the front of a replay device or a control module, as text or symbols on a TV screen, or can be output audibly, for example by a synthesized speech output.

A broadcast content storage system according to the present invention comprises at least one receiver for receiving broadcast contents transmitted over a broadcast channel, a storage unit for storing the broadcast contents and a processing unit. The processing unit is configured so that received broadcast contents, described by a content descriptor, are automatically allocated to a content category defined by the corresponding content descriptor, and that the broadcast contents allocated to a content category are automatically stored in the appropriate content category in the storage unit.

This system can be realised completely or partially in a central facility of a broadcasting network, a different communication network, or in the user's home.

The broadcast content storage system preferably comprises at least two receivers to allow parallel reception of several broadcast channels.

In a further preferred embodiment—for the case that reception, processing and storing are all performed by a central network server—a control module allows the user to access the central network server to download broadcast contents from the network server for local viewing for example using broadband internet.

A control module for a broadcast content storage system according to the present invention comprises in particular a display module for displaying quantitative information concerning the broadcast contents stored in the storage system, broken down according to the appropriate content categories. Such quantitative information might inform the user, for example, whether appropriate broadcast contents are stored in memory, the duration of the stored broadcast contents, whether the duration exceeds a certain limit, or the number of stored broadcast contents.

Other objects and features of the present invention will become apparent from the following detailed descriptions considered in conjunction with the accompanying drawing. It is to be understood, however, that the drawings are designed solely for the purposes of illustration and not as a definition of the limits of the invention.

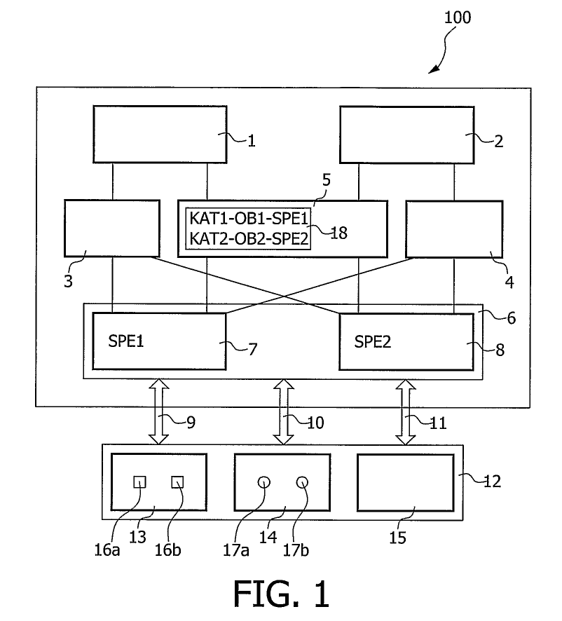

FIG. 1 is a block diagram of the system architecture of a broadcast content storage system with a control module;

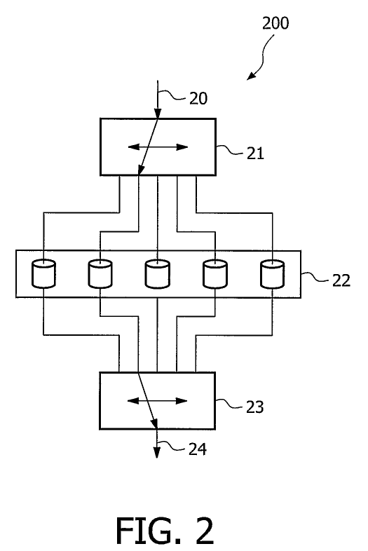

FIG. 2 is a block diagram of a broadcast content storage system in accordance with an embodiment of the present invention

FIG. 1 shows a broadcast content storage system 100, connected to a control module 12 via appropriate interfaces 9, 10, 11. The broadcast content storage system 100 and the control module 12 can be realised as a single device in the vicinity of the user, or might be realised as separate devices, for example where the user has a control module 12 at home, and the broadcast content storage system 100 is realised as a network element of a broadcast provider or other service provider. The control module 12 or elements of the control module 12 can also be realised as part of the broadcast content storage system 100. The control module 12 or the broadcast content storage system 100 together with control module 12 can also be realised as an intelligent audio and/or video recorder.

In the following, FIG. 1 illustrates not only the operation of the individual components of the broadcast content storage system 100 and the control module 12 and how they act together, but also illustrates in more detail the steps of an exemplary method for storing broadcast contents.

For the sake of clarity, FIG. 1 only shows the relevant components of a broadcast content storage system 100, namely a control module 12, and interfaces 9, 10 and 11. It is to be understood that such a broadcast content storage system 100 also comprises any other components that generally belong to such analysis and storage systems, for example cables, processors, power supply, switches, buses, routers, etc.

The broadcast content storage system 100, shown in FIG. 1, comprises two receiver systems 1,2, to each of which is routed a broadcast transmission channel, for example an antenna output signal.

The broadcast contents (video or audio contents) transferred over the broadcast transmission channels are received by broadcast receiver systems 1,2, and stored in a buffer 3,4, e.g. on a hard-disk.

Concurrently to the buffering, the received broadcast content is examined in a central processing unit 5, which might be realised as a programmable processor, to see if it is described by pre-defined content descriptors or not. To this end, the processing unit 5 avails of a memory unit 18, in which various content descriptors OB1, OB2 or combinations of content descriptors are specified for the definition of various content categories KAT1, KAT2. The user or a service provider has read/write access to this memory unit 18 via a suitable definition interface (not shown in the diagram) in order to define content categories as required.

The processing unit 5 is equipped with the necessary technology such that content descriptors can be extracted from the broadcast content using suitable known methods of analysis such as speech recognition and speaker identification, and compared to the stored content descriptors OB1, OB2. If the degree of association between extracted content descriptors and stored content descriptors OB1 exceeds a pre-defined threshold level, this implies that the analysed broadcast content is indeed described by the content descriptor OB1, and is to be allocated to the corresponding content category KAT1.

Once the end of the broadcast content belonging to content category KAT1 has been reached, the beginning (start time or start address of the buffer) is also determined, and the broadcast content is stored at an address based on the storage address SPE1, assigned to the corresponding content category KAT1 in the storage unit 6, which can be realised as, for example, a hard-disk.

The various memory addresses SPE1, SPE2 for the content categories KAT1, KAT2 can also be realised as references or pointers to the storage sectors 7,8 reserved for the content categories KAT1, KAT2.

Besides analysis of the broadcast contents, the processing unit 5, or a processing module realised for this particular function, is also responsible for controlling and coordinating the individual components of the broadcast content storage system 100 and the interfaces 9, 10, 11, described in more detail below.

The broadcast content storage system 100 is connected to a control module 12 via a number of interfaces 9, 10, 11. The interfaces 9, 10, 11 can be partially or entirely based on an internet connection or other standard or proprietary communication or data-bus protocol.

The control module 12, which can also be controlled via its own suitable processing unit, requests from time to time, via the query interface 9, quantitative information about the broadcast contents stored in various storage sectors 6, 7 of the broadcast content storage system 100, broken down according to content category. As a matter of course, the invention also covers the additional or alternative variation wherein quantitative information about the broadcast contents stored in various storage sectors 6, 7 of the broadcast content storage system 100 are communicated from time to time by the broadcast content storage system 100 to the control module 12.

The quantitative information thus queried or supplied is displayed on a display unit 13. An optical element 16a, 16b such as a light-emitting diode (LED) is assigned to each content category KAT1, KAT2. A selector element 17a, 17b, for example a button, is assigned to each optical element 16a, 16bas part of the selection module 14.

If an optical element 16a indicates that a broadcast content is stored in the memory sector 6 corresponding to content category KAT1, the user can select this broadcast content or content category by activating the corresponding element 17a assigned to the optical element 16a.

Information regarding the broadcast content or content category selected by the user are then communicated to the broadcast content storage system 100 via the selection interface 10. A transfer over a content transfer interface 11 of the selected broadcast contents, or the broadcast contents of a selected content category, from the broadcast content storage system 100 is thereby initiated.

The local broadcast storage 15 can be realised as part of the control module 12 or as part of a broadcast content replay module, for example a display. An alternative, also within the scope of the invention, allows the transfer of the selected broadcast contents or the broadcast contents of a selected content category from the broadcast content storage system 100 directly to a local broadcast content replay module, e.g. a display, a TV device or a TV screen.

A further embodiment of the invention provides a transfer of information concerning the stored broadcast contents, such as title, names of actors etc. to the control module 12 as an intermediate step before or accompanying the transfer of broadcast contents to the control module 12. This information allows the user to make a more informed choice, and helps avoid needless transfers of broadcast contents from the broadcast content storage system 100 to the control module 12.

FIG. 2 shows an alternative arrangement for a broadcast content storage system 200, realised for example as a video content storage system, and comprising a video input 20. The incoming video contents are routed to one of several storage sectors by a switch 21, depending on whether or not they are described by a pre-defined content descriptor and can therefore be allocated to a corresponding content category. This switch 21 therefore operates as a kind on content classifier, distributing the incoming video contents over the storage sectors according to the appropriate content category.

A second switch 23 is used to route the video content from a specified storage sector in the storage unit 22 to the video output 24, according to a selection made by the user.

Although the present invention has been disclosed in the form of preferred embodiments and variations thereon, it will be understood that numerous additional modifications and variations could be made thereto by a person skilled in the art, without departing from the scope of the invention. For example, the method for storing broadcast contents might be extended to include billing and digital rights management systems. Also, the broadcast content storage system and/or the control module might be incorporated partially or entirely in a personal computer.

For the sake of clarity, it is also to be understood that the use of “a” or “an” throughout this application does not exclude a plurality, and “comprising” does not exclude other steps or elements. A “unit” or “module” may comprise a number of blocks or devices, unless explicitly described as a single entity. The term “hardware” can mean digital or analogue hardware, and might mean any type of circuitry such as boards, integrated circuits, off-the-shelf modules, custom modules etc.

1. A method for storing broadcast contents, comprising:
pre-defining a plurality of content categories;
defining each of the content categories by at least one content descriptor;
receiving broadcast contents transmitted over at least one broadcast transmission channel;
automatically assigning the received broadcast contents, described by a content descriptor, to a content category which is defined by the corresponding content descriptor;
and automatically storing the broadcast contents and the assignments of the broadcast contents.

2. The method according to claim 1, further comprising
assigning a storage address to each of the content categories,
the broadcast contents assigned to a content category being automatically stored according to the storage address assigned to the corresponding content category.

3. The method according to claim 1,
where quantitative information about the stored broadcast contents is shown, according to content categories (KAT1, KAT2).

4. The method according to claim 3, wherein a pre-allocated storage capacity is allotted to each content category, and the degree to which the pre-allocated storage capacity is occupied is shown.

5. The method according to claim 1, wherein
the received broadcast contents, described by a logical combination of several content descriptors, are automatically assigned to the content category defined by the corresponding logical combination of several content descriptors.

6. The method according to claim 1, wherein
the broadcast contents, transmitted over a plurality of broadcast channels, are received simultaneously.

7. The method according to claim 1, wherein
at least one of the beginning and the end of a broadcast content is transmitted as an accompanying signal with the broadcast content.

8. The method according to claim 1, wherein
the content descriptors (OB1, OB2) are transmitted as accompanying signals with the broadcast contents.

9. The method according to claim 1, wherein
information about the broadcast contents, assigned to the content category, is automatically shown to the user upon selection of the content category.

10. A broadcast content storage system, comprising:
at least one receiver for receiving broadcast contents transmitted over a broadcast channel;
a storage unit for storing broadcast contents; and
a processing unit which is configured in such a way that the received broadcast contents, described by a content descriptor, are automatically assigned to a content category defined by the corresponding content descriptor and that the broadcast contents assigned to a content category are automatically stored in the storage unit under allocation to the corresponding content category.

11. The broadcast content storage system according to claim 10, further comprising
a display unit for displaying quantitative information regarding the stored broadcast contents according to content categories.

12. A control module for a broadcast content storage system according to claim 10, comprising
a query interface to the broadcast content storage system for requesting quantitative information regarding the stored broadcast contents, broken down according to content categories and
a display unit for displaying quantitative information regarding the stored broadcast contents, broken down according to the corresponding content categories.

13. The control module according to claim 12, comprising
with a content selection unit for user selection of a stored broadcast content or a content category,
and a selection interface to the broadcast content storage system for transferring information regarding the user selected broadcast content or content category.

14. The control module according to claim 12, comprising
a content transfer interface to the broadcast content storage system for transferring a selected broadcast content or broadcast contents of a selected content category to a local broadcast storage.
